(19) United States
(12) Patent Application Publication
(10) Pub. No.: US 2002/0088827 A1
(43) Pub. Date: Jul. 11, 2002

(54) Variable volume wine bottle

(76) Inventor: Dominick Colucci, Torrington, CT (US)

Correspondence Address: ST. ONGE STEWARD JOHNSTON & REENS, LLC, 986 BEDFORD STREET, STAMFORD, CT, 06905-5619, US

(21) Appl. No.: 10/039,739

(22) Filed: Jan. 5, 2002

Related U.S. Application Data
(60) Provisional application No. 60/260,135, filed on Jan. 5, 2001.

(51) Int. Cl. B67D 5/42

(52) U.S. Cl. 222/386

(57) ABSTRACT

A method and apparatus for minimizing light exposure and expelling air from a container of wine while at the same time containing, preserving and dispensing the wine. The method of the invention comprises varying the volume of a container with a movable piston to purge the container of air and minimizing degradation of the wine by shielding the wine from light in the container. The apparatus comprises a body for containing wine, a cap for closing the top of the body, a piston movable with a handle within the body for adjusting the volume, and a top portion of the body which is at least in part translucent such that the level of the wine is ascertainable as the piston is moved in the body.

### FIELD OF THE INVENTION

The present invention relates to a method and a specialized bottle to preserve, store, and dispense wine, as well as to protect the wine from degradation due to exposure to air and light. More particularly, the present invention relates to a container for preserving, storing, and containing wine or another oxidizable liquid by minimizing air in the container through the variation of the volume of the container to approximate the volume of the undispensed wine or liquid.

### BACKGROUND OF THE INVENTION

Several devices and methods have been used or proposed to deal with the degradation of wine due to exposure to air after the original wine bottle has been opened and some of the wine dispensed. One arrangement involves the use of a plastic bag in a box as shown in FIG. 1A. A valve or spigot sealed to the bag is accessible from outside the box for withdrawing wine as needed. The bag collapses from the force of atmospheric pressure as wine is withdrawn, so the remaining wine is minimally exposed to the air. Since the entire container is discarded when empty, this arrangement is somewhat expensive and is only used for packages of comparatively large quantity such as three liters or more.

Another method for dealing with the exposure to air involves the use of a pump attached to the opening of a wine bottle as shown in FIG. 1B. This pump is employed for the purpose of removing as much air as possible from the volume inside the bottle where air has displaced some of the wine. While this may be somewhat effective, there is a limit to how much of a vacuum can be created by such a simple pump.

Another apparatus for reducing exposure to air, which is disclosed in U.S. Pat. No. 6,105,803 to Standish, involves the use of two nested containers as shown in FIG. 2. The wine is poured in the outer container and the inner container is screwed into the outer container, thereby forcing the wine to the top of the container and displacing the air above the wine. While this method would also seem to be effective, it is somewhat cumbersome and utilizes a device which does not resemble a wine bottle. It would appear that to store the entire volume of a standard bottle of wine in this container requires it to be unscrewed to an unwieldy height. This is due to the dead space surrounding the central neck 10, which is required to create enough downward pressure to push the wine up to the top of the container. In addition, because the wine bathes the inner container, there may be problems cleaning and maintaining the unit. Another problematic feature of this design is the use of threads 11 to allow movement of the inner container within the outer container. This movement would be smoother if the inner container could slide within the outer container, rather than be twisted. In fact, the threads require extra space and material to function. During the lifetime of the apparatus, the threads might become cross-threaded, stripped, or clogged with dirt or debris. Because the threads must screw and unscrew, they do not form a fluid tight seal, thus necessitating the use of an extra sealing element between the inner and outer containers 12. Further, only a pouring neck 13 may be transparent or translucent for viewing the level of the wine. This is a very small viewing area that makes it difficult to ascertain the level of the wine and could lead to loss of wine through spillage or degradation of wine through too much of an air pocket at the top.

In the present invention, once wine is dispensed, a piston is pushed up inside the container, thereby pushing the wine to the top, minimizing the air between the wine and the cap. The above-mentioned problems are overcome by the simple, smooth sliding operation of the piston in the container. By utilizing the piston, this invention is an efficient design minimizing dead space and maintaining a constant outward appearance (i.e. it takes up a set volume regardless of the amount of wine stored inside). This enables the invention to closely resemble a wine bottle in both appearance and function. In addition, the bottle is largely opaque or translucent to prevent degradation of the wine from light. The tapered top end of the present invention is largely translucent or transparent, allowing for a much larger area to view the wine level. Storing, cleaning and maintaining the device is straightforward due to the simplicity of design. The device is easy to maintain hygienically: to clean the unit, the bottom is simply removed and the device may be washed by hand in the sink or in an automatic dishwasher. The handle and base may be kept clean by wiping with a cloth. Further, the method for using the bottle to preserve, store, and dispense wine can be readily learned by anyone that has poured wine before.

Finally, there are a number of apparatus which utilize a varying volume design to expel unwanted air from the flexible liner of a baby nursing bottle. The flexible liner is typically supported by a cylindrical, open-ended shell body and a nipple which holds the liner to the shell. One such type is commonly known as the “Playtex baby nurser” manufactured by the Playtex Corporation. Baby nursing bottles such as this require that air in the chamber formed by the nipple and the liner cavity be expelled manually prior to the start of feeding. Nightingale, U.S. Pat. No. 5,033,631 discloses an apparatus that uses a built-in plunger device to compress the inner-liner of the baby nurser and expel the air. Sullivan, U.S. Pat. No. 5,109,996 discloses a plunger that may be inserted to compress the inner-liner of a baby nurser. Grobbel, U.S. Pat. No. 3,648,873 is proposed in which a plunger on a separate stand is used to purge air from a nursing system. Hammer, U.S. Pat. No. 3,955,698 shows a relatively complex spring and plunger system for expelling air from such a nursing system. Miller, U.S. Pat. No. 4,176,754 shows a “pneumatic biasing member” which attempts to solve the problem. McKeown, U.S. Pat. No. 4,796,767 shows a pressure applicator having a generally L-shaped cross section for expelling air from the collapsible bag of such a nursing bottle. Lebeau, U.S. Pat. No. 4,880,125 discloses a relatively straightforward plunger system do dispel air from the collapsible nursing bottle. Askerneese, U.S. Pat. No. 4,979,629 discloses an air expeller system for a nursing bottle which includes a measuring cup device which, when inverted within the nurser, can be used to expel air from the collapsible bag. Wiedemann, U.S. Pat. No. 5,356,016 discloses a movable plunger for compressing the collapsible bag in a baby nurser.

Unfortunately, these baby nursing technologies are designed to work with compressible and collapsible liquid containers such as small disposable plastic bags which are typically used to contain baby formula or milk. Such designs lack the fluid-tight seal necessary to contain a liquid such as wine directly in a container body, i.e. a bottle. In addition, there are frequently leakage problems with the liner bags used in baby nursers which would make them unfit for containing wine. Also, the plastic used in baby nursers could adversely affect the flavor of the wine. Further, many of the baby bottle nursers require a special nipple at the top to prevent air from reentering the liner. The present invention has a piston with sufficient friction to prevent it from sliding back down the tube, thus no special top is needed for the bottle.

Applicant has devised a practical container and method for preserving, storing and dispensing wine. The container resembles a typical wine bottle with the distinction that the bottom of the bottle can be raised and lowered within the body of the container. To use the container, all or some of the contents of a full regular (750 ml) bottle of wine are poured into the variable volume wine bottle. The bottom of the device is then pushed upwards within the container with the handle until the level of the wine is almost at the top of the container, as viewed through a translucent or transparent portion of the top of the container. When the volume of air above the wine has been minimized, the cap is placed on the container and the container may be stored as a normal bottle of wine. The body of the container is ideally opaque or at least translucent to prevent degradation of the wine by light during use and storage.

When wine is desired, the cap is simply removed from the container and wine is dispensed from the opening at the top. After dispensing wine, the handle is again used to raise the bottom of the bottle so that the volume of the container closely approximates the volume of the undispensed wine. The cap is again placed on the bottle and the wine may be stored until next use. When the container is empty, i.e. there is no more wine to be dispensed, then the handle can be used to pull the bottom of the bottle to its lowest position. The wine bottle is then ready to be used again with a new bottle of wine.

### BRIEF DESCRIPTION OF THE DRAWINGS

This invention may be more clearly understood with the following detailed description and by reference to the drawings in which:

FIG. 1A is a perspective view, partly in phantom, of a prior art device for minimizing contact of wine with air as it is decanted from a container;

FIG. 1B is a straight view of another type of prior art device for removing air from a wine bottle with a pump device;

FIG. 2 is a cross-section view of another type of prior art device for limiting contact of wine in a bottle with air utilizing nested cylinders;

FIG. 3 is a perspective view of the container, optional base, and handle of the invention;

FIG. 4 is a detailed view of the head of the handle, showing one possible means of attaching the handle to the base depicted in FIG. 3.

FIG. 5 is an exploded view of the container, base and handle of FIGS. 3 and 4, note that the movable piston element 5 is shown outside of the body of the container.

FIG. 6 is a cross section of the container of the invention filled with wine to almost the top with the piston in its lowest position.

FIG. 7 is a perspective view of the piston of FIGS. 5, 6 and 7 alone.

FIG. 8 is a cross section detail of the piston of FIGS. 5 and 6 as positioned in a fluid tight manner within the body of the container.

FIG. 9 is a cross section view of the container partially filled with wine with the piston in the lowest position being contacted by the handle of the invention.

FIG. 10 is a cross section view of the container partially filled with wine with the piston being adjusted to a height at which the volume of the container approximates the volume of undispensed wine by use of the handle of the invention.

FIG. 11 is a perspective view of a bowtie latch to attach the handle to the base of the invention.

FIG. 12 is a perspective view of the underside of the piston with a bowtie receptacle for the bowtie latch on the head of the handle depicted in FIG. 11.

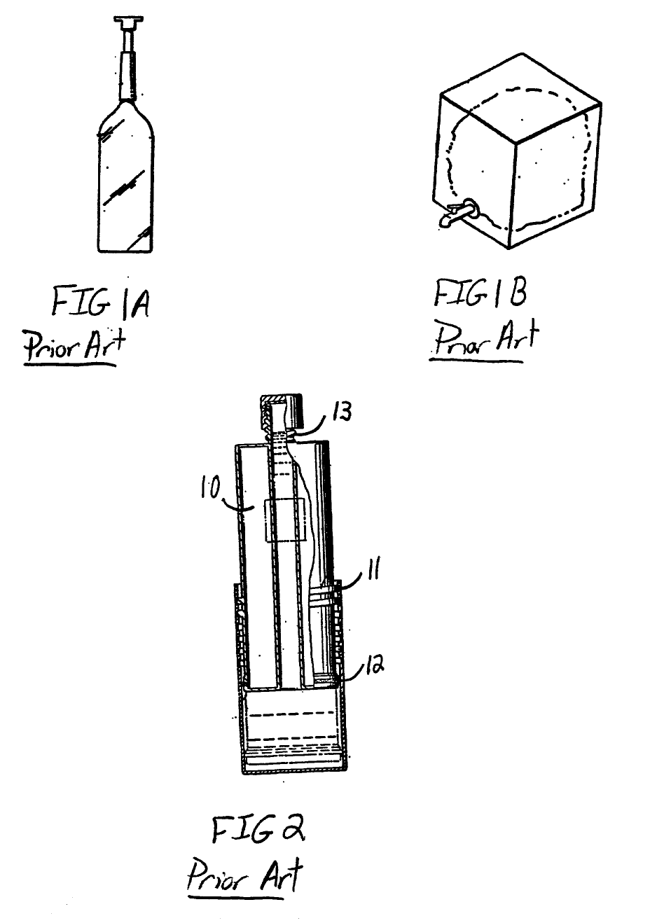

### DETAILED DESCRIPTION OF THE DRAWINGS

FIG. 3 is a perspective view of the container 20, optional base 21, and handle 22 of the invention including a cylindrical body 23, a tapered top portion of said body 24, a cap 25, a handle 22 of sufficient length to pull and push the piston throughout the length of the cylindrical body 23, and an attachment 26 on the head of the handle. As displayed, the body 23 has a broad bottom 27 for standing alone or on the base 21.

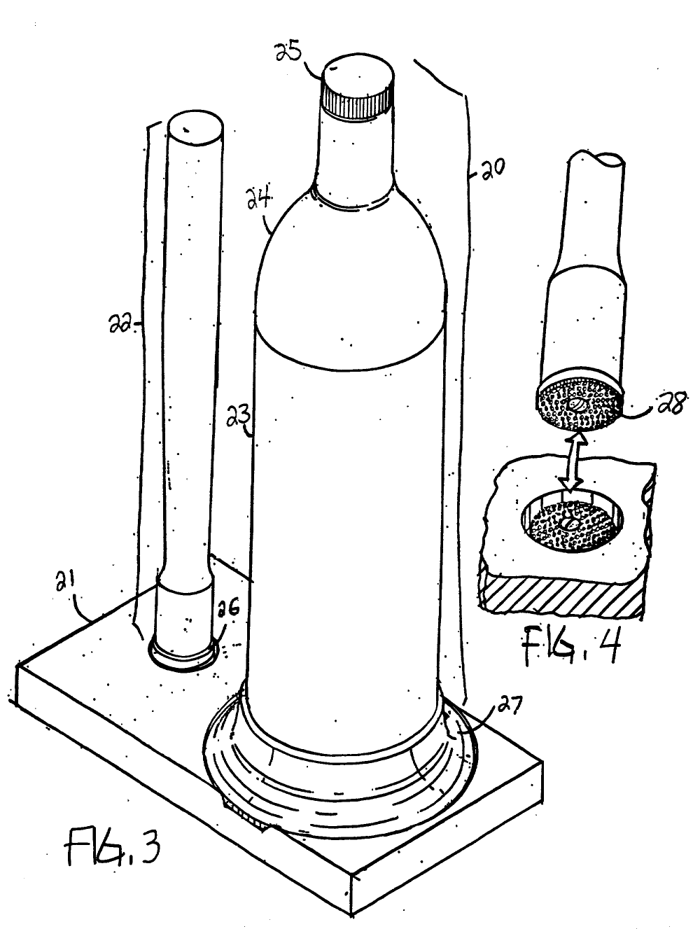

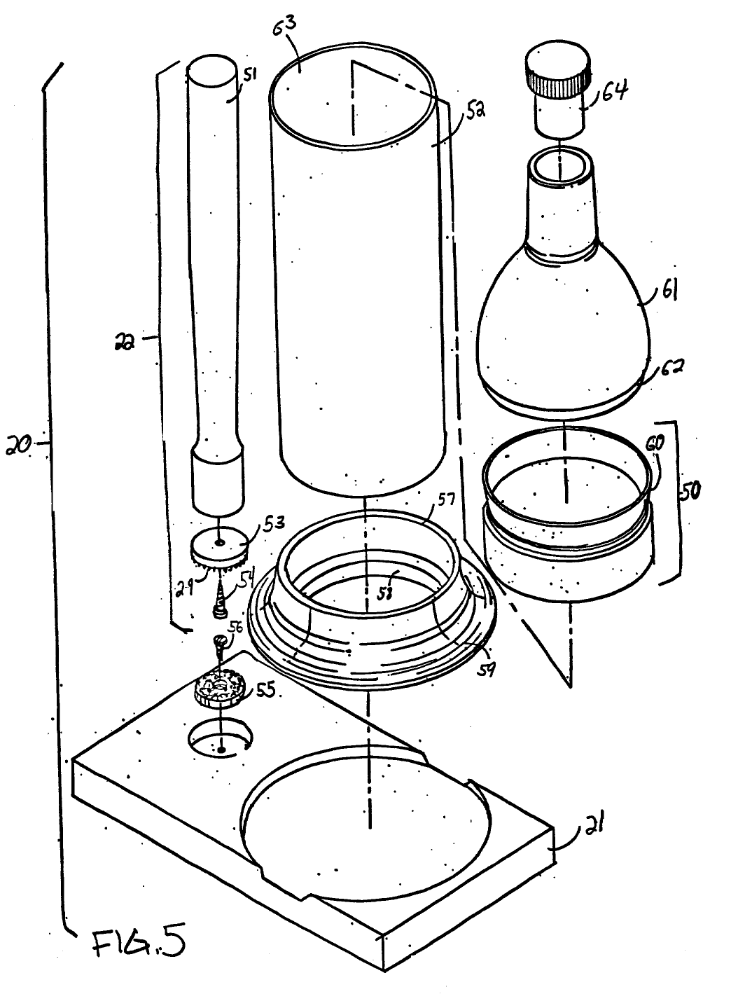

FIG. 4 is a detailed view of the head of the handle 22, showing one possible means of affixing the handle 22 to the base depicted in FIG. 3 and to the piston 60. This attachment uses a plurality of small knobs 28 that form a binding nonpermanent connection when enmeshed, and can easily be separated by pulling the handle off at an angle. These knobs may be any flexible material that is rigid enough to lock into place, such as plastic. FIG. 11 shows another possible attachment mechanism is a bowtie connection 110 which can be inserted into a matching hole 111, twisted to lock in place, and twisted in the reverse direction to unlock. The bowtie connection 110 may be constructed of any material that is durable enough to last the lifetime of the device and repeated lockings and unlockings, such as hardened plastic or metal. Other connection mechanisms are also possible, such as a standard hook and loop fastener system.

FIG. 5 is an exploded view of the container 20, base 21 and handle 22 of FIGS. 3 and 4, note that the movable piston element 50 is shown outside of the body of the container. The handle 22 includes a rod 51 of sufficient length to push and pull the piston 50 through the length of a cylindrical portion 52 of the container 20. The rod 51 may be of any durable material such as wood, plastic, or metal. The head of the handle has a means for temporarily attaching to the underside of the piston 50 and the base 21. Here, the attachment is a disc 53 with a plurality of knobs 29 fastened to the rod 51 with a screw 54. The knobs on this disc can become enmeshed with the knobs on a similar disc 55 that is fastened to the base with a screw 56. In this way the handle can be stored until needed. The cylindrical portion 52 of the body is open at both ends, is of a sufficient diameter to frictionally engage the piston 50, may be made of any durable material that is ideally opaque but may be translucent, does not affect the flavor of the wine, may be decorated on the exterior, and is capable of storing and preserving wine in a fluid tight manner, such as metal, glass, or plastic. One embodiment contemplates the cylindrical portion 52 is made of stainless steel. A broad base segment 57 is attached to the bottom of the cylindrical portion 52 of the container 20. In one embodiment, the broad base segment 57 is removably attached to the bottom of the cylindrical portion 52 to facilitate cleaning and maintenance of the device. The broad base segment 57 is of sufficient diameter to encompass the cylindrical portion 52 that fits on a protruding inner lip 58 of the broad base 57, wherein said lip 58 also serves to prevent the piston from being fully withdrawn from the cylindrical portion 52. In a second embodiment, the broad base has a flared outer lip 59 of sufficient diameter to allow the container 20 to stand alone, may be made of any durable material, and may be decorated on the exterior, such as metal, glass, or plastic. Another embodiment contemplates the cylindrical portion is made of polypropylene plastic.

Referring again to FIG. 5, the piston 50 sits in the cylindrical portion 52, has a flared surface 60 which frictionally engages the interior of the cylindrical portion 52 in a fluid tight manner, and is capable of moving upwards and downwards throughout the length of the cylindrical portion 52 in a fluid tight manner such that the wine remains contained by the piston 50. The underside of the piston 50 has an attachment for the handle 22 (see detail in FIG. 7). The piston 50 may be made of any durable material that does not affect the flavor of the wine and is capable of storing and preserving wine in a fluid tight manner, such as metal, glass, or plastic. One embodiment contemplates the cylindrical portion is made of Polypropylene plastic.

FIG. 5 also shows the container 20 has a tapered top portion 61 attached in a fluid tight manner with the top of the cylindrical portion 52. A silicone sealant or a silicone adhesive may be used if desired to form a fluid tight fit. The tapered top portion 61 has an inner protruding lip 62 that fits inside the top opening 63 of the cylindrical portion 52. In one embodiment, the wine is initially poured through the top opening of the tapered top portion 61. In another embodiment, the wine is poured through the top opening of the tapered top portion 61 with the assistance of a funnel. In yet another embodiment, the tapered top portion 61 is removably attached to the cylindrical portion 52, so that it can be removed, the wine poured in, and the tapered top portion 61 replaced. The tapered top portion 61 may be made of any durable material that is ideally translucent but may be transparent, does not affect the flavor of the wine, may be decorated on the exterior, and is capable of storing and preserving wine in a fluid tight manner, such as glass, or plastic. One embodiment contemplates the tapered top portion 61 is made of Polypropylene plastic. A removable cap 64 fits in a fluid tight manner in the top of the tapered top portion 61 to close the container. The cap 64 may be made of any durable material that is ideally opaque but may be translucent, does not affect the flavor of the wine, may be decorated on the exterior, and is capable of storing and preserving wine in a fluid tight manner, such as wood, cork, plastic or metal. In one embodiment, the cap 64 is made of cork.

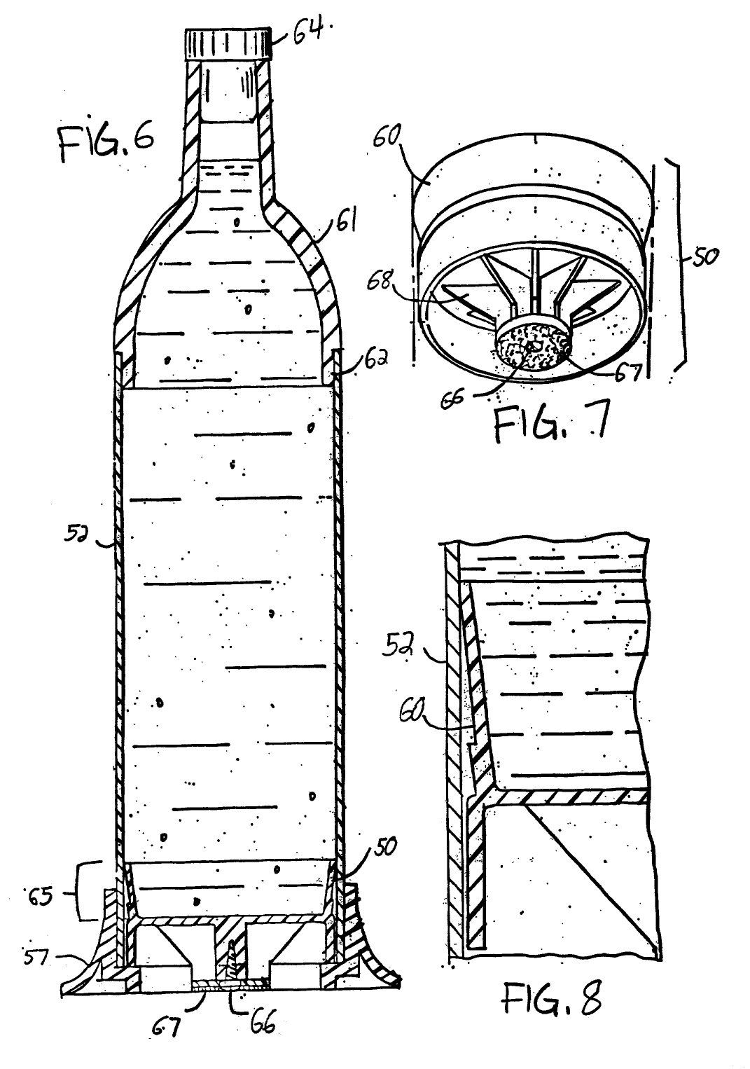

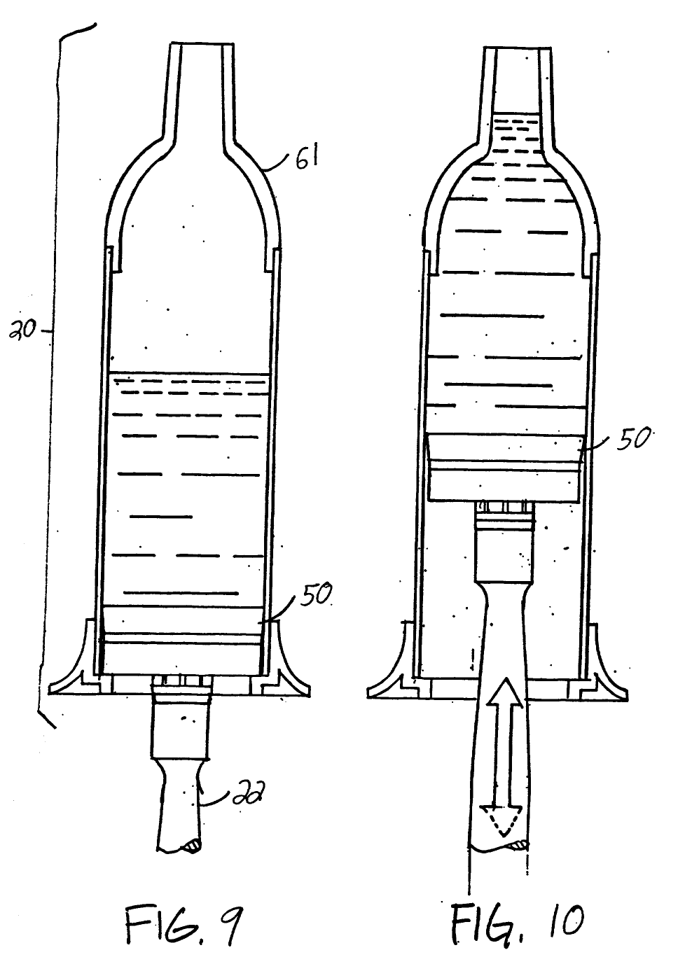

FIG. 6 is a cross section of the container 20 of the invention filled with wine to almost the top with the piston 50 in its lowest position. In the embodiment shown, the flared surface 60 of the piston 50 extends above the top surface of the piston 50 creating a cup shape 65 capable of holding wine, thus allowing the overall size of the container 20 to be smaller than if the volume encompassed by the flared surface 60 was solid (see detail in FIG. 8). In one embodiment, a screw 66 affixes a handle attachment feature 67 to the underside of the piston 50. Other fixatives can be used separately or in combination to affix the handle attachment feature 67 to the underside of the piston 50, such as nails, glue, staples, or solder. The cylindrical portion 52 of the container 20 fits tightly in the broad base 57 and it rests on the inner protruding lip 58 that also serves as a stop to the piston 50. The tapered top 61 fits in a fluid tight manner on the cylindrical portion 52. In one embodiment, the tapered top 61 has an inner lip 62 that stops the piston 50 at the top of the cylindrical portion 52. The cap 64 fits in a fluid tight manner in the tapered top 61.

FIG. 7 is a perspective view of the piston 50 of FIGS. 5, 6 and 7 alone. In one embodiment, a screw 66 affixes a handle attachment feature 67 to the underside of the piston 50. In this embodiment, the handle 22 is pushed upwards into the piston 50 so that the handle attachment feature 66 engages and the piston 50 can be pushed or pulled with the handle 22. In one embodiment the handle attachment feature 66 is reinforced with vanes 68 on the underside of the piston. In another embodiment, the flared surface 60 of the piston has a greater outer diameter than the bottom section of the piston 50 to allow for smooth movement within the cylindrical portion 52 of the container 20.

FIG. 8 is a cross section detail of the piston of FIGS. 5 and 6 as positioned in a fluid tight manner within the body of the container. In the displayed embodiment, only the top portion of the flared surface 60 contacts the inner wall of the cylindrical portion 52 of the container, thus allowing for smooth movement of the piston 50 while maintaining a fluid tight seal

FIG. 9 is a cross section view of the container 20 partially filled with wine with the piston 50 in the lowest position being contacted by the handle 22 of the invention. In one embodiment, the level of the wine can be ascertained by viewing through the tapered top 61. In one embodiment, the cap 64 is removed, the piston 50 is pushed upwards with the handle 22 to raise the level of the wine and reduce the air space on top, and the cap 64 is then replaced.

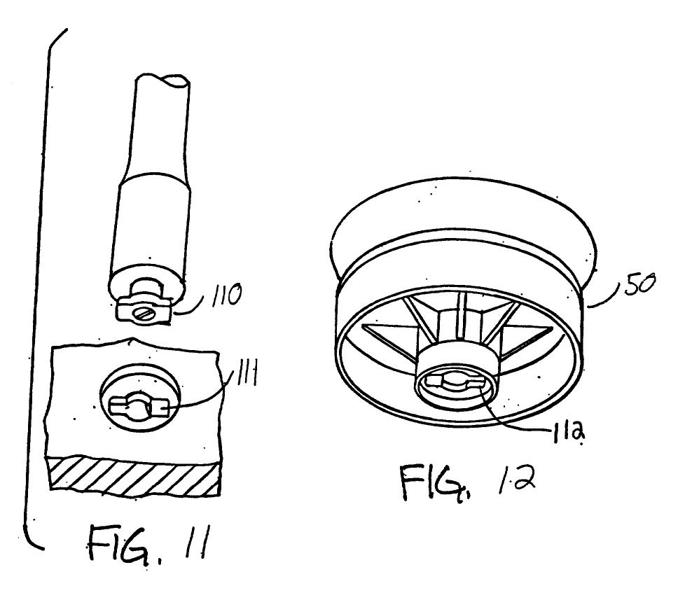

FIG. 10 is a cross section view of the container 20 partially filled with wine with the piston 50 in a position at which the volume of the container approximates the volume of undispensed wine.

FIG. 11 is a perspective view of a bowtie latch 110 to attach the handle 22 to the base 21 of the invention. In one embodiment the bowtie latch 110 is inserted into a bowtie receptacle 111 and rotated to lock the handle 22 in place.

FIG. 12 is a perspective view of the underside of the piston with a bowtie receptacle 112 for the bowtie latch 110 on the head of the handle 22 depicted in FIG. 11. In one embodiment the bowtie latch 110 is inserted into a bowtie receptacle 111 and the handle 22 with the bowtie latch 110 rotated to lock the handle 22 in place, the piston 50 is then moved upwards and downwards within the cylindrical portion 52, and the handle 22 can be removed by rotating the handle 22 with the bowtie latch 110 in the other direction to unlock the handle 22.

The above-described embodiments of the present invention are merely descriptive of its principles and are not to be considered limiting. For example, while the specification is written describing a container for receiving the contents of a 750 ml bottle, the invention is suitable for and can be made in any desired size. In addition, while the above-described elements focus on wine, it should be understood that substantially any oxidizable substance may be preserved, contained and dispensed. Moreover, the body of the container may be cylindrical, or it may have any of a number of other shapes, such as polygonal. The scope of the present invention instead shall be determined from the scope of the following claims including their equivalents.

What is claimed is:

1. A device for preserving, containing, and dispensing a volume of wine by purging said device of air comprising:
a body for containing the wine, said body comprising a substantially cylindrical stainless steel portion and a tapered top portion which together form the outward appearance of a continuous bottle, said top portion comprising a neck extending from said body and having an opening for dispensing the wine;
a cap for closing the neck opening in a fluid tight manner removably secured to said neck and closing said opening;
a piston movable within said body in a fluid tight manner for adjusting the volume inside said body;
a handle detachably connected to said piston for moving said piston within said body, wherein after wine is dispensed from the body, the piston is moved by pushing with the handle to adjust the volume of the container to approximate the volume of undispensed wine;
a bottom fastened to the cylindrical portion of said body with a broad base for standing alone, wherein said bottom prevents the piston from being fully withdrawn from said body; and
wherein said top portion is at least in part translucent such that the level of the wine is ascertainable as the piston is moved in the body, wherein the top portion includes a protruding lip sized to frictionally engage the inner diameter of the cylindrical portion of the body in a fluid tight relation, and wherein said protruding lip has an inner diameter sufficient to allow passage of wine while preventing the piston from being pushed into said top portion.

2. A device for preserving, containing, and dispensing a volume of wine by purging said device of air comprising:
a body for containing the wine,
said body including at the top thereof a neck having an opening for dispensing the wine extending from said body,
a cap for closing the neck opening in a fluid tight manner removably secured to said neck and closing said opening,
a piston movable within said body in a fluid tight manner for adjusting the volume inside said body,
and a handle detachably connected to said piston for moving said piston within said body.

3. The device according to claim 2, wherein after wine is dispensed from the body, the piston is moved by pushing with the handle to adjust the volume of the container to approximate the volume of undispensed wine.

4. Structure as set forth in claim 2 wherein the body comprises a substantially cylindrical portion and a tapered top portion which together form the outward appearance of a continuous bottle; wherein said top portion is at least in part translucent such that the level of the wine is ascertainable as the piston is moved in the body.

5. Structure as set forth in claim 2 wherein the body is opaque so as to prevent degradation of the wine by light.

6. Structure as set forth in claim 2 wherein the body is translucent so as to prevent degradation of the wine by light.

7. The device according to claim 4 wherein the body has a bottom fastened to the cylindrical portion of said body with a broad base for standing alone, wherein said bottom prevents the piston from being fully withdrawn from said body.

8. Structure as set forth in claim 7 wherein the top includes a protruding lip sized to frictionally engage the inner diameter of the cylindrical portion of the body in a fluid tight relation; wherein said protruding lip has an inner diameter sufficient to allow passage of wine while preventing the piston from being pushed into said top.

9. A device for preserving, containing, and dispensing wine comprising:
a body with a tapered top end and
a piston movable within said body in a fluid tight manner for adjusting the remaining volume inside said body in order to minimize air above the wine, wherein said body, said neck, and said piston define a substantially fluid tight volume and said volume is adjustable to approximate the volume of undispensed wine.

10. The device as set forth in claim 9 wherein the tapered top end is translucent at least in part.

11. The device as set forth in claim 9 wherein the tapered top end is transparent at least in part.

12. A method for preserving, containing, and dispensing a volume of wine by varying the volume of a container with a movable piston to purge said container of air and minimizing degradation of the wine by shielding the wine from light in said container, said method comprising the steps of:
providing a container with a movable piston contained therein, said container having a neck with a cap,
providing a handle which is detachably connectable to the piston for moving said piston in the container towards the neck,
pouring a volume of wine into the container,
closing the cap,
storing the wine until needed,
removing the cap,
dispensing the wine by pouring it from the container,
adjusting the volume of the container to approximate the volume of undispensed wine by pushing the piston with the handle,
securing the cap, and
removing the handle.

13. Method as set forth in claim 12 further comprises dispensing the first portion of wine, then adjusting the volume of the container to approximate the volume of the undispensed wine, storing the remaining wine, and repeating the process whenever wine is dispensed.

14. Method as set forth in claim 14 wherein the volume of the container is varied by moving a piston forwards and backwards through the interior of the container in a manner that minimizes the amount of air between the wine and the top of the container.

15. Method as set forth in claim 15 wherein the level of the wine during movement of the piston is determined by observation through a translucent section at the top of the container.

16. Method as set forth in claim 15 wherein the level of wine during movement of the piston is determined by observation through a transparent section at the top of the container.
